(19) United States
(12) Patent Application Publication
(10) Pub. No.: US 2005/0066180 A1
(43) Pub. Date: Mar. 24, 2005

(54) Authentication apparatus and authentication method

(75) Inventor: Keisuke Watanabe, Mizuho-city (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 10/915,349

(22) Filed: Aug. 11, 2004

(30) Foreign Application Priority Data
Sep. 24, 2003 (JP) 2003-332497

(51) Int. Cl. H04K 1/00

(52) U.S. Cl. 713/186

(57) ABSTRACT

An input unit receives a fingerprint image and a fingerprint width category symbol from a user. A switching controller controls switches based on the fingerprint width category symbol. In the case of the fingerprint width being standard, the switching controller performs switching so that the input/output operation of a feature extraction unit is performed using a standard fingerprint width feature extraction process. In the case of the fingerprint width being narrow, the switching controller performs switching so that the input/output operation of the feature extraction unit is performed using a narrow fingerprint width feature extraction process. The feature extraction unit extracts fingerprint feature data by applying the standard fingerprint width feature extraction process to a standard width fingerprint image and the narrow fingerprint width feature extraction process to a narrow width fingerprint image. A to-be-authenticated data generation unit generates data to be authenticated based on the extracted fingerprint feature data and a fingerprint authentication unit collates the data to be authenticated with fingerprint authentication data registered in a fingerprint authentication database.

### BACKGROUND OF THE INVENTION

1. Field of the Invention

The present invention relates to authentication technology, and it particularly relates to an authentication apparatus and an authentication method for implementing individual authentication using biometric data.

2. Description of the Related Art

In biometric authentication using biometric data such as fingerprint, palm print, face, iris, or voiceprint as an object to be authenticated, conditions such as the parameters for the feature extraction process, which is implemented upon authentication data registration and authentication, are tuned and fixed in accordance with a typical type of biometric data. For example, the image processing resolution and various parameters used in the fingerprint feature extraction method are optimized based on a typical type of fingerprint like an adult person's fingerprint and accordingly a threshold and constant are determined. In the fingerprint authentication, image processing and feature extraction are implemented by using such optimized set values upon fingerprint registration and authentication, which enables the guaranteeing of a certain level of authentication accuracy.

In the case the feature extraction process is implemented using different set values and conditions between registration and authentication while using the same authentication threshold, the probability of rejecting a registered person, in other words, the probability of not recognizing a registered person as a registered person increases. On the other hand, to reduce the probability of rejecting a registered person, the authentication threshold may be set loosely. But, in that case, the probability of accepting an unregistered person, in other words, the probability of mistakenly recognizing an unregistered person as a registered person increases. Therefore, the changing of the process parameters by individual feature differences for an object to be authenticated is not done.

In the case of biometric authentication, huge amounts of time are necessary for an authentication database search and collation processing. Therefore, to speed up the authentication process, the objects to be authenticated are sorted by the users' age and gender etc. (For example, refer to the related art list: [1])

Related Art List

[1] Japanese Patent Application Laid-Open No. 2002-8035

In a fingerprint authentication system, the image processing resolution and minutiae extraction filter are tuned in accordance with a typical type of user. Therefore, the problem has been that when a person has an atypical fingerprint condition, for example small fingers with unusually fine fingerprint streaks or rough surface fingers, a fingerprint authentication system cannot be used. The present state is that an alternative system such as a password authentication is offered to such users who cannot use a fingerprint authentication system to operate an authentication system. However, such a way of operating a system is contrary to the purpose of adopting a biometric authentication system, which is to improve the security level.

This applies not only to fingerprint authentication but also to iris authentication and face authentication. Since there are individual feature differences among the objects to be authenticated, which will necessitate adjusting the process parameters, it is unavoidable that there will be users who cannot be screened by an authentication system based on typical biometric data. This will cause inconvenience in the operation of the authentication system.

### SUMMARY OF THE INVENTION

The present invention has been made in view of foregoing circumstances, and an object thereof is to provide an authentication technology applicable to users who cannot be screened by a common authentication system because of their atypical physical features.

According to one aspect of the present invention, an authentication apparatus is provided. The apparatus comprises an authentication data input unit which receives both an input of biometric data of an object to be authenticated and an input of identification data used to determine a category for the biometric data from among a plurality of categories broadly defined by individual feature differences. These categories broadly defined by individual feature differences are the categories set up so that a necessary adjustment to the authentication process system can be made to handle physical feature differences among users.

The authentication apparatus may further comprise an authentication process unit, which, based on the identification data used to determine the category, implements authentication by switching to a feature extraction process appropriate for the category. The authentication apparatus may further comprise: an authentication database in which a storage area is divided into a plurality of sub-areas for the respective categories to register the biometric data of users; and an authentication process unit which performs a search in the corresponding storage sub-area in the authentication database based on the input identification data used to determine the category, and thereby collates the input biometric data of the object to be authenticated.

By using this apparatus, since the input of the broadly defined category for the biometric data is received from a user, it is possible to apply a feature extraction process appropriate for the category, which can help expand the base of users. In addition, by performing a search in an authentication database in which a storage area is divided logically or physically into a plurality of sub-areas for the respective categories, it is possible to increase the process speed and improve authentication accuracy.

According to another aspect of the present invention, an authentication apparatus is also provided. The apparatus comprises: an authentication data input unit which receives an input of biometric data of an object to be authenticated; an assignment unit which assigns a category for the input biometric data from among a plurality of categories broadly defined by individual feature differences; and a display unit which shows the category which has been assigned. The authentication apparatus may further comprise: an authentication database in which a storage area is divided into a plurality of sub-areas for the respective categories to register the biometric data of users; and a registration unit which, based on the category assigned by the assignment unit, registers the input biometric data in the corresponding storage sub-area in the authentication database.

According to still another aspect of the present invention, an authentication method is provided. The method comprises: receiving both an input of biometric data of an object to be authenticated and an input of data used to determine a category for the biometric data from among a plurality of categories broadly defined by individual feature differences; extracting features by switching, based on the identification data used to determine the category, to a feature extraction process appropriate for the category; and performing a search in the authentication database in which the storage area is divided into a plurality of sub-areas for the respective categories and the biometric data of users are registered and thereby collating the input biometric data of the object to be authenticated.

Moreover, any arbitrary replacement or substitution of the above-described structural components and the steps, expressions replaced or substituted in part or whole between a method and an apparatus as well as addition thereof, and expressions changed to a system, a computer program, a storage medium, a transmission medium or the like are all effective as and are encompassed by the present invention.

This summary of the invention does not necessarily describe all necessary features, so that the invention may also be a sub-combination of these described features.

### BRIEF DESCRIPTION OF THE DRAWINGS

FIG. 1 is a block diagram of a fingerprint registration apparatus according to the embodiment.

FIGS. 2A and 2B are diagrams describing fingerprint input data to be input to the fingerprint registration apparatus in FIG. 1.

FIG. 3 is a block diagram of another type of a fingerprint registration apparatus according to the embodiment.

FIG. 4 is a block diagram of a fingerprint authentication apparatus according to the embodiment.

FIG. 5 is a block diagram of an authentication system according to the embodiment.

FIG. 6 is a flowchart describing a fingerprint registration procedure by the fingerprint registration apparatus in FIG. 3.

FIG. 7 is a flowchart describing a fingerprint authentication procedure by the fingerprint authentication apparatus in FIG. 4.

### DETAILED DESCRIPTION OF THE INVENTION

The invention will now be described by reference to the preferred embodiments. This does not intend to limit the scope of the present invention, but to exemplify the invention.

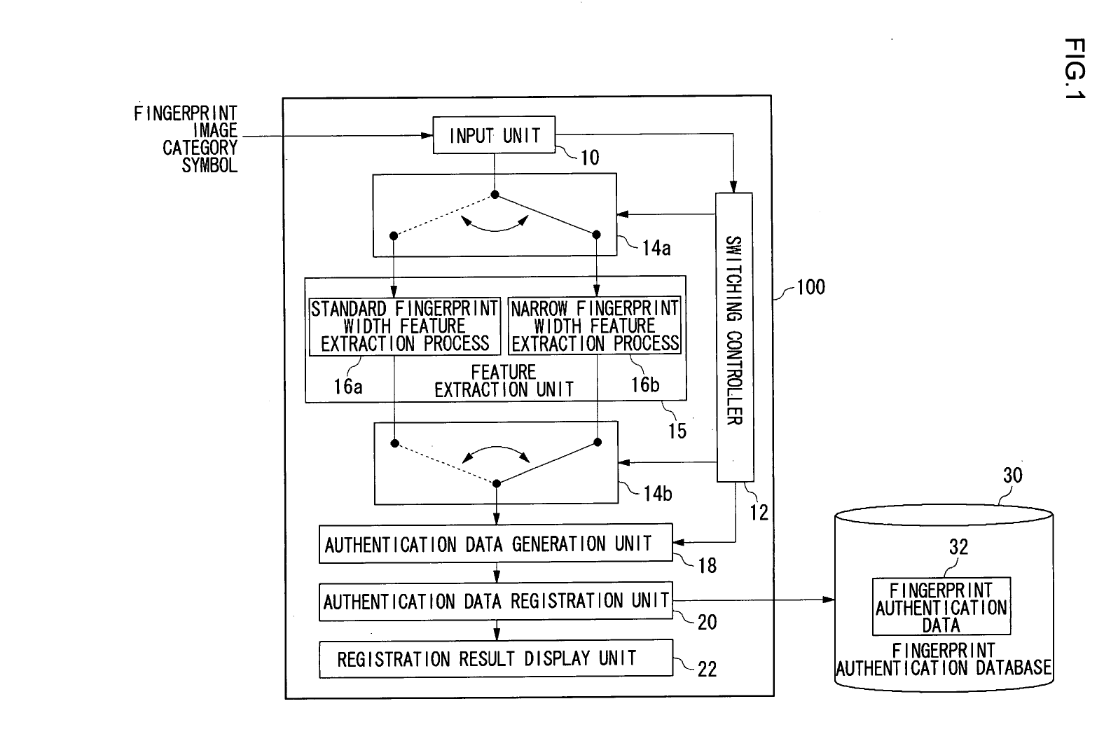

FIG. 1 is a block diagram showing the fingerprint registration apparatus 100 according to the embodiment of the present invention. This configuration can be realized by, in terms of hardware, using an optional computer CPU, memory, and other LSIs and by, in terms of software, using elements such as a program with a fingerprint authentication process function loaded in the memory. In the figure, functional blocks are described, which are realized through the interaction of the above components. Therefore, it should be understood by those skilled in the art that these functional blocks can be realized in various ways such as hardware only, software only, or a combination thereof.

The input unit 10 receives a fingerprint image and a category symbol from a user. The category symbol indicates a category from among a plurality of broadly defined categories and enables handling of a case in which switching of the fingerprint extraction process is necessary due to a physical feature difference. For example, categories can be set up based on a certain age group like an adult age group and child age group, gender, fingerprint width degree etc. Here, an example of categories is shown. The standard fingerprint width category is assumed to be that of an adult man's fingerprint width, and the narrow fingerprint width category is assumed to be that of a woman or child.

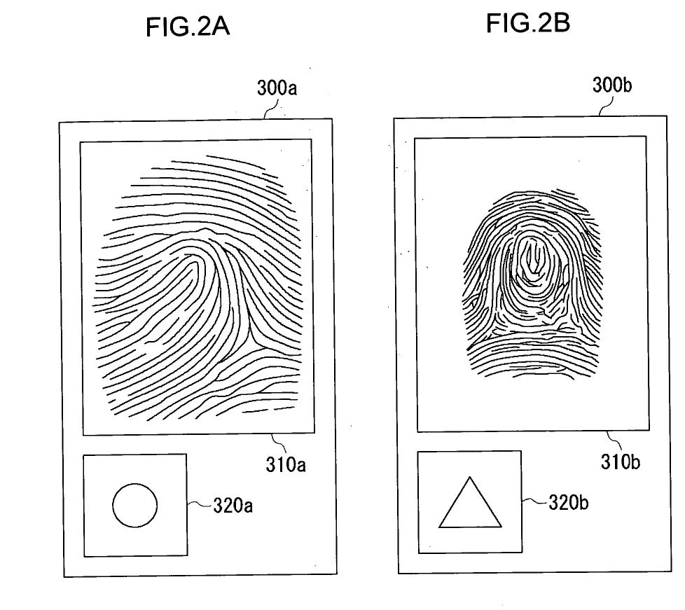

FIG. 2A is a diagram describing the fingerprint input data 300a of a user who has a standard width fingerprint. The standard width fingerprint input data 300a comprises the standard fingerprint width fingerprint image 310a and the standard fingerprint width category symbol 320a. The standard fingerprint width category symbol 320a is indicated by the symbol “Circle.” Meanwhile, FIG. 2B is a diagram describing the fingerprint input data 300b of a user who has a narrow width fingerprint. The narrow width fingerprint input data 300b comprises the narrow width fingerprint image 310b and the narrow fingerprint width category symbol 320b. The narrow fingerprint width category symbol 320b is indicated by the symbol “Triangle.” The user has been informed in advance of their fingerprint width, either standard or narrow, and inputs the fingerprint width category symbol 320a or 320b together with their fingerprint.

With reference again to FIG. 1, the switching controller 12 performs switching operation at the switches 14a and 14b based on the fingerprint width category symbol 320a or 320b which has been input to the input unit 10, and selects either the standard fingerprint feature extraction process 16a or the narrow fingerprint feature extraction process 16b, which are set up in the feature extraction unit 15. In the case of the standard fingerprint width category symbol 320a, the switches 14a and 14b are switched so that the input/output operation of the feature extraction unit 15 is performed using the standard fingerprint width feature extraction process 16a. In the case of the narrow fingerprint width category symbol 320b, the switches 14a and 14b are switched so that the input/output operation of the feature extraction unit 15 is performed using the narrow fingerprint width feature extraction process 16b.

For the standard width fingerprint image 310a, the feature extraction unit 15 extracts fingerprint feature data such as minutiae by applying the standard fingerprint width feature extraction process 16a and for the narrow width fingerprint image 310b, extracts fingerprint feature data by applying the narrow fingerprint width feature extraction process 16b, and thereby outputs the extracted fingerprint feature data.

The authentication data generation unit 18 generates the fingerprint authentication data 32 which stores, in a prescribed format, the fingerprint feature data extracted by the feature extraction unit 15 and the fingerprint width category symbol given by the switching controller 12. The authentication data registration unit 20 records the fingerprint authentication data 32 which has been generated, in the fingerprint authentication database 30. The registration result display unit 22 displays a message on the display etc. to inform the user of the completion of fingerprint registration. Meanwhile, if registration cannot be completed due to insufficient fingerprint feature extraction because of an unclear fingerprint image etc., the registration result display unit 22 displays a message to ask for re-input of a fingerprint image.

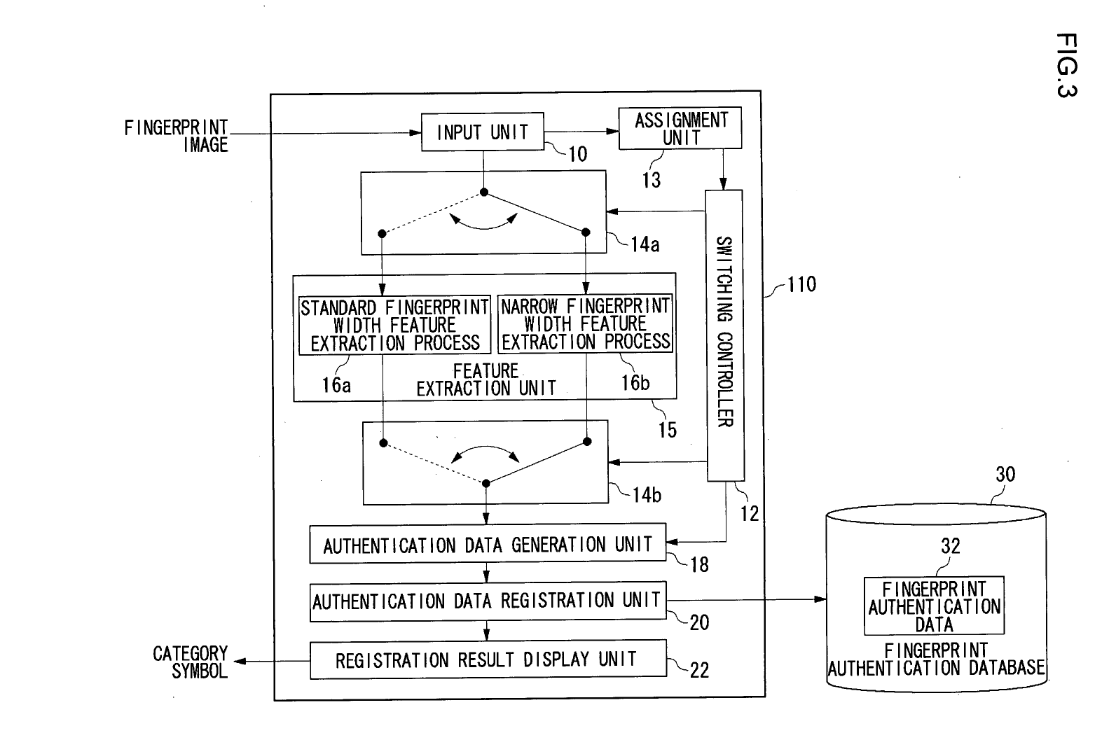

FIG. 3 is a block diagram of another type of the fingerprint registration apparatus 110. While the fingerprint registration apparatus 100 in FIG. 1 is configured so that it registers a fingerprint after receiving an input of a fingerprint image and category symbol from a user, the fingerprint registration apparatus 110 in FIG. 3 is configured so that it registers a fingerprint after receiving an input of a fingerprint image from a user and automatically assigning its category, and thereby shows the category symbol to the user. For the structures common with those in the fingerprint registration apparatus 100 in FIG. 1, the same numerals will be given and explanation will be omitted and only the different structures will be explained.

The assignment unit 13 judges whether the fingerprint width of the fingerprint image, which has been input to the input unit 10, is standard or narrow. This judgment may be delivered by image processing or by using data other than the fingerprint image. For example, in the case that the registered user data includes a user's gender or age, it is possible to judge a user's fingerprint width from their gender or age.

The switching controller 12 controls the switches 14a and 14b based on the fingerprint width category assigned by the assignment unit 13. In the case of standard fingerprint width, the switching controller 12 performs switching so that the input/output operation of the feature extraction unit 15 is performed using the standard fingerprint width feature extraction process 16a. In the case of narrow fingerprint width, the switching controller 12 performs switching so that the input/output operation of the feature extraction unit 15 is performed using the narrow fingerprint width feature extraction process 16b. Then, after going through the processes at the authentication data generation unit 18 and the authentication data registration unit 20, if a registration has been normally completed, the registration result display unit 22 shows the category symbol indicating the assigned fingerprint width category to the user.

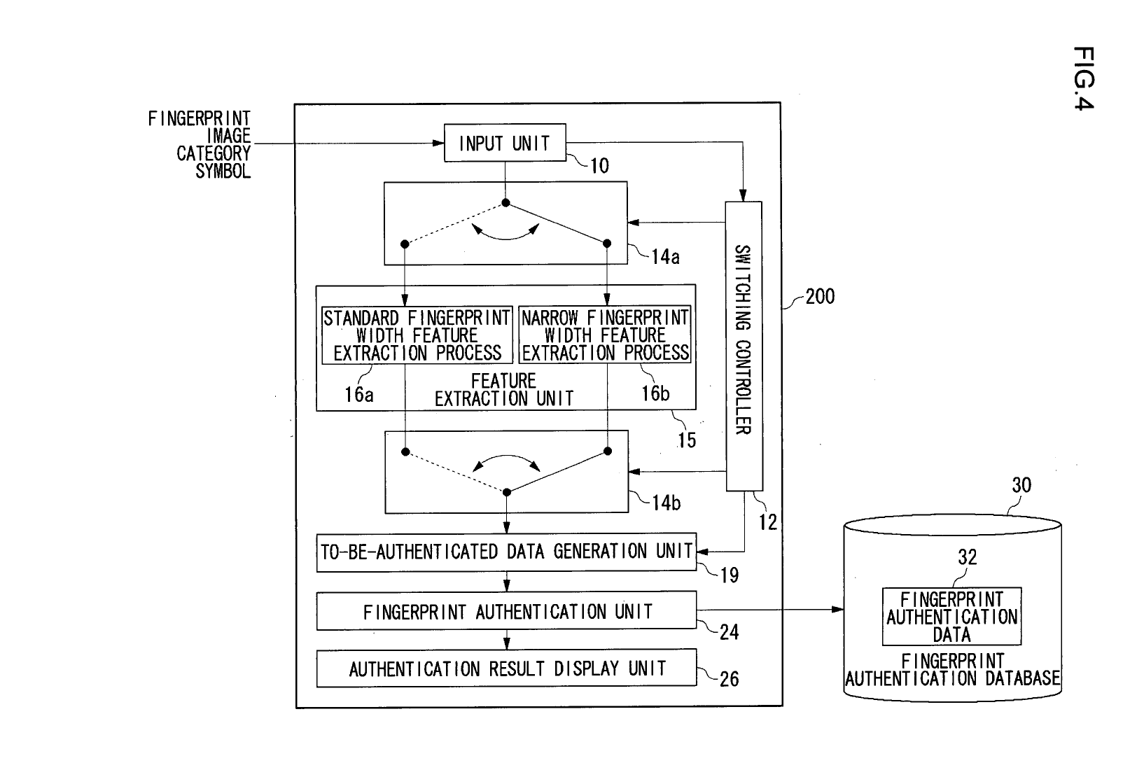

FIG. 4 is a block diagram of the fingerprint authentication apparatus 200 according to the embodiment of the present invention. These functional blocks can also be realized in various ways such as hardware only, software only, or a combination thereof. The fingerprint authentication apparatus 200 authenticates a user's fingerprint by receiving an input of a fingerprint image and category symbol from the user. Among the structural components of the fingerprint authentication apparatus 200, the input unit 10, the switching controller 12, the switches 14a and 14b, and the feature extraction unit 15 are respectively common with those with the same codes in the fingerprint registration unit 100 in FIG. 1.

The to-be-authenticated data generation unit 19 generates the fingerprint data to be authenticated which stores, in a prescribed format, the fingerprint feature data extracted by the feature extraction unit 15 and the fingerprint width category symbol given by the switching controller 12. The fingerprint authentication unit 24 collates the fingerprint data to be authenticated generated by the to-be-authenticated data generation unit 19 with the fingerprint authentication data 32 registered in the fingerprint authentication database 30 and checks to see if there is a matching data. As a result of collation, when the fingerprint is judged to be that of a registered user, the authentication result display unit 26 displays a message indicating success of authentication to the user. If the fingerprint does not match with that of any registered users, the authentication result display unit 26 displays a message indicating failure of authentication to the user.

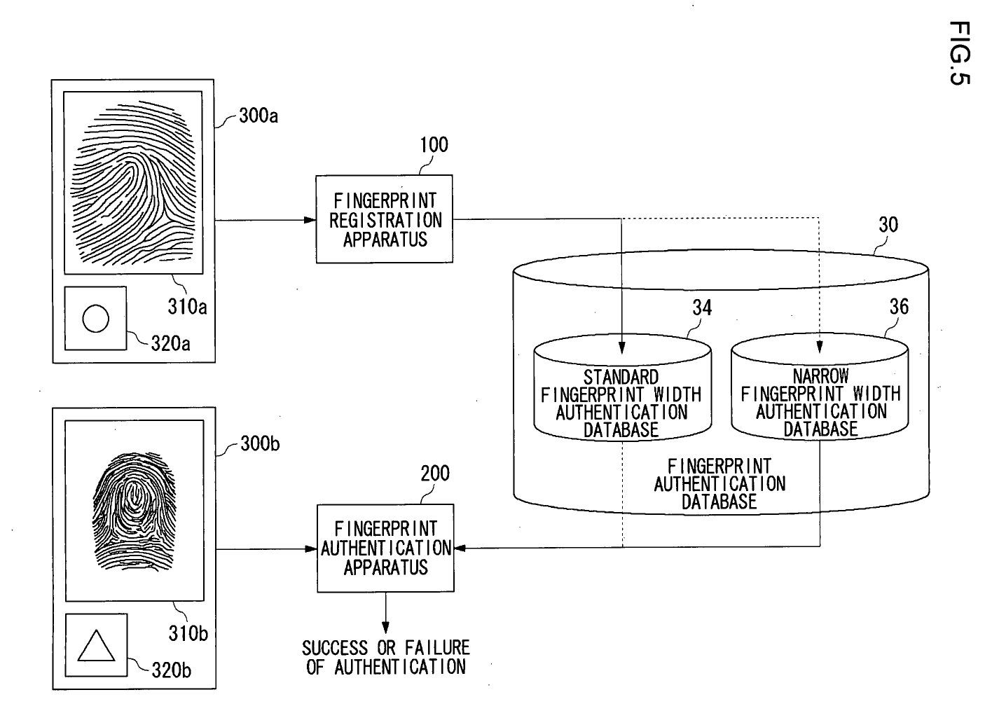

FIG. 5 is a block diagram of an authentication system according to the embodiment of the present invention. The authentication system is configured so that the fingerprint registration apparatus 100 in FIG. 1 and the fingerprint authentication apparatus 200 in FIG. 2 share and access the fingerprint authentication database 30. The storage area of the fingerprint authentication database 30 is divided physically and logically into a plurality of sub-areas for the standard fingerprint width authentication database 34 and for the narrow fingerprint width authentication database 36.

Upon registration, when a user inputs the standard width fingerprint input data 300a to the fingerprint registration apparatus 100, as stated previously, the fingerprint registration apparatus 100 applies the feature extraction process for standard fingerprint width to the input fingerprint image, generates the fingerprint authentication data, and registers it in the standard width authentication database 34.

Upon authentication, when another user inputs the narrow width fingerprint input data 300b to the fingerprint authentication apparatus 200, the fingerprint authentication apparatus 200 applies the feature extraction process for narrow fingerprint width to the input fingerprint image, generates the to-be-authenticated fingerprint data, and collates it with the registered user's fingerprint data in the narrow fingerprint width authentication database 36. And then it displays either a success or failure of authentication.

Since the fingerprint authentication database 30 is divided based on fingerprint width into two sub-areas for the standard fingerprint width authentication database 34 and for the narrow fingerprint width authentication database 36, the number of objects to be collated is down to a half of what it would be in the case of the database being undivided, which helps to speed up a search. Also, in this way, the objects to be collated are made more specific so the authentication accuracy can be improved.

As another type of an authentication system, the fingerprint registration apparatus 110 in FIG. 3 may be used instead of the fingerprint registration apparatus 100 in FIG. 1. Upon registration, the fingerprint registration apparatus 110 receives an input of only a fingerprint image from a user, assigns the fingerprint width category, and notifies the user of the fingerprint width category symbol. The user shall memorize the category symbol and upon registration, input both a fingerprint image and the category symbol to the fingerprint authentication apparatus 200.

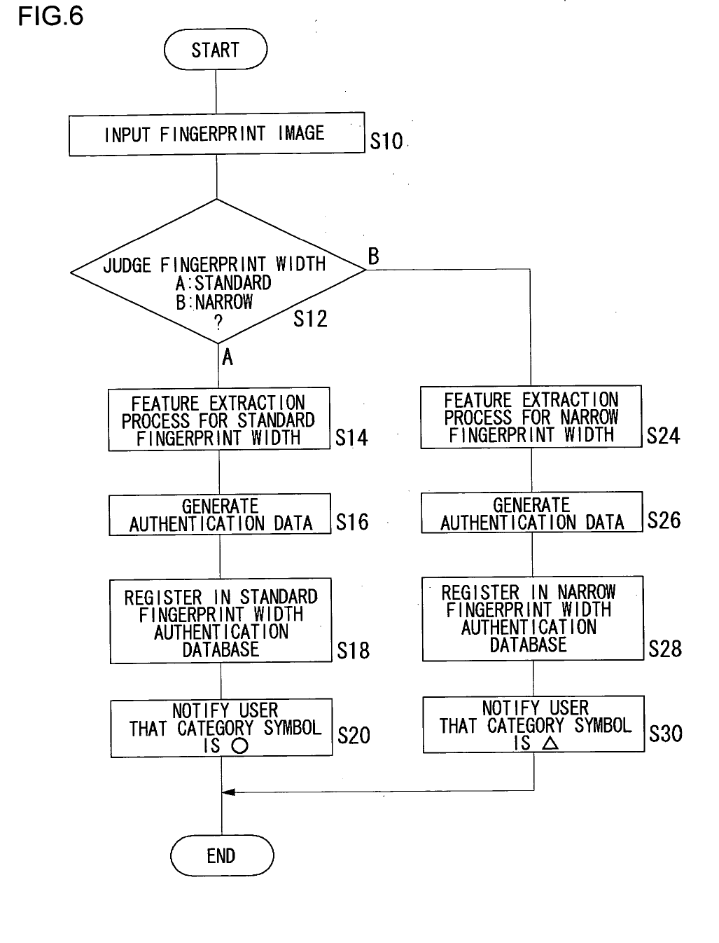

The fingerprint registration procedure and the fingerprint authentication procedure by the authentication system configured as above will be explained. Here, the operation of the authentication system using the fingerprint registration apparatus 110 in FIG. 3, which automatically assigns the fingerprint width category, will be explained. FIG. 6 is a flowchart describing the fingerprint registration procedure by the fingerprint registration apparatus 110.

The user inputs a fingerprint image to the input unit 10 of the fingerprint registration apparatus 110 (S10). The assignment unit 13 judges the fingerprint width based on the input fingerprint image (S12). When the assignment unit 13 judges that the fingerprint width is standard (S12A), the feature extraction unit 15 implements the feature extraction process for standard fingerprint width on the fingerprint image (S14), the authentication data generation unit 18 generates the fingerprint authentication data 32 based on the extracted fingerprint feature data (S16), and the authentication data registration unit 20 registers the fingerprint authentication data 32 in the standard width authentication database 34 (S18). The registration result display unit 22 notifies the user with the standard width category symbol “Circle” (S20).

When the assignment unit 13 judges that the fingerprint width is narrow (S12B), the feature extraction unit 15 implements the feature extraction process for narrow fingerprint width on the fingerprint image (S24), the authentication data generation unit 18 generates the fingerprint authentication data 32 based on the extracted fingerprint feature data (S26), and the authentication data registration unit 20 registers the fingerprint authentication data 32 in the narrow width authentication database 36 (S28). The registration result display unit 22 notifies the user with the narrow width category symbol “Triangle” (S30).

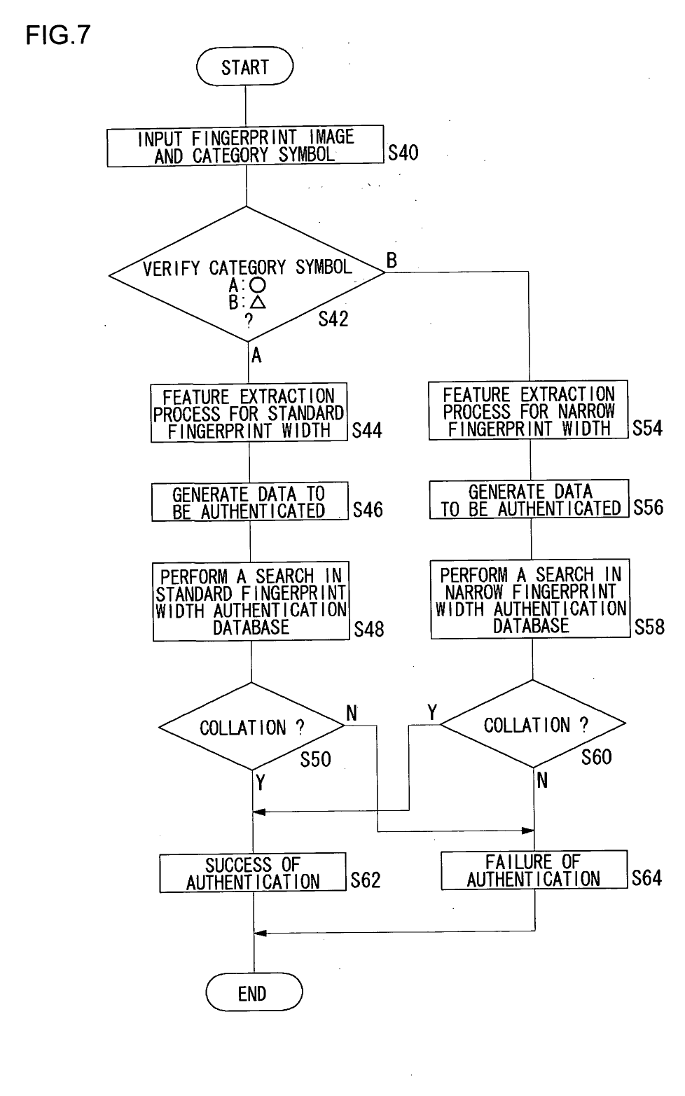

FIG. 7 is a flowchart describing the fingerprint authentication procedure by the fingerprint authentication apparatus 200. The user inputs a fingerprint image and a category symbol to the input unit 10 of the fingerprint authentication apparatus 200 (S40). The switching controller 12 switches the process at the feature extraction unit 15 based on the input category symbol (S42).

The procedure in the case of the category symbol indicating standard fingerprint width will be explained (S42A). The feature extraction unit 15 implements the feature extraction process for standard fingerprint width on the fingerprint image (S44) and the to-be-authenticated data generation unit 19 generates the fingerprint data to be authenticated based on the extracted fingerprint feature data (S46). The fingerprint authentication unit 24 performs a search in the standard fingerprint width authentication database 34 (S48) and collates the fingerprint data to be authenticated with the fingerprint authentication data 32, which has been registered (S50). As a result of collation, if the fingerprint authentication data 32 congruent with the fingerprint data to be authenticated exists in the standard fingerprint width authentication database 34 (S50Y), the authentication result display unit 26 notifies the user of a success of authentication (S62). If the fingerprint authentication data 32 congruent with the fingerprint data to be authenticated does not exist in the standard fingerprint width authentication database 34 (S50N), the authentication result display unit 26 notifies the user of a failure of authentication (S64).

Next, the procedure in the case of a category symbol indicating narrow fingerprint width will be explained (S42B). The feature extraction unit 15 implements the feature extraction process for narrow fingerprint width on the fingerprint image (S54) and the to-be-authenticated data generation unit 19 generates the fingerprint data to be authenticated based on the extracted fingerprint feature data (S56). The fingerprint authentication unit 24 performs a search in the narrow fingerprint width authentication database 36 (S58) and collates the fingerprint data to be authenticated with the fingerprint authentication data 32, which has been registered (S60). As a result of collation, if the fingerprint authentication data 32 congruent with the fingerprint data to be authenticated exists in the narrow fingerprint width authentication database 36 (S60Y), the authentication result display unit 26 notifies the user of a success of authentication (S62) If the fingerprint authentication data 32 congruent with the fingerprint data to be authenticated does not exist in the narrow fingerprint width authentication database 36 (S60N), the authentication result display unit 26 notifies the user of a failure of authentication (S64).

As explained above, in the fingerprint authentication apparatus 200 according to the embodiment of the present invention, since the user inputs a fingerprint width category symbol, it is not necessary to judge the width of the fingerprint on the system side and it is possible to switch the image processing resolution and the minutiae extraction filter to those appropriate for the fingerprint width based on the input category symbol. In this way, it is possible to distinguish the differences between physical features and to authenticate more users. Furthermore, by dividing the fingerprint authentication database 30 logically or physically into a plurality of sub-areas for the categories, search efficiency and authentication accuracy can be improved.

Although the present invention has been described by way of exemplary embodiments, it should be understood that many changes and substitutions may further be made by those skilled in the art without departing from the scope of the present invention which is defined by the appended claims.

In the above, the authentication system was explained by using fingerprint authentication as an example. However, the present invention can also be applied to biometric authentication systems using other kinds of data such as palm print, face, iris, vein, voiceprint etc. For example, as for palm print authentication, by broadly defining categories for adult or child, gender, and finger circumference etc., it is possible to optimize the resolution etc. for each category. As for iris authentication, by broadly defining categories for eye color, it is possible to switch the image processing method. As for voiceprint authentication, by defining categories for voice pitch, gender, adult or child, age group etc., it is possible to adjust voice recognition parameters etc. for each category.

The category symbols as described above may be something simple for the users to remember like a single digit number. Also, select buttons may be set up for adult/child, male/female etc. so that the users can input their category by pressing an appropriate button when inputting their biometric data. Also, a sensor may be set up to detect the height of a user to judge whether the person is an adult or child. In this way, the category data for adult or child can be automatically obtained without having a user input a category symbol.

In the embodiment, the fingerprint registration apparatuses 100 and 110 are configured separately from the fingerprint authentication apparatus 200. However, the functions of the fingerprint registration apparatuses 100 and 110 may be included in the fingerprint authentication apparatus 200 to make them into an integrated system. In this case, some structural components can be shared, such as the input unit 10, the switching controller 12, the switches 14a and 14b, and the feature extraction unit 15, which can simplify the authentication system configuration.

1. An authentication apparatus comprising an authentication data input unit which receives both an input of biometric data of an object to be authenticated and an input of identification data used to determine a category for the biometric data from among a plurality of categories broadly defined by individual feature differences.

2. The apparatus of claim 1, further comprising an authentication process unit which, based on the identification data used to determine the category, implements authentication by switching to a feature extraction process appropriate for the category.

3. The apparatus of claim 1, further comprising:
an authentication database in which a storage area is divided into a plurality of sub-areas for the respective categories to register the biometric data of users; and
an authentication process unit which performs a search in the corresponding storage sub-area in the authentication database based on the input identification data used to determine the category, and thereby collates the input biometric data of the object to be authenticated.

4. The apparatus of claim 1, wherein the biometric data is a fingerprint data and the categories are categories defined by fingerprint width degrees.

5. The apparatus of claim 2, wherein the biometric data is a fingerprint data, the categories are categories defined by fingerprint width degrees, and the feature extraction process appropriate for the category is a fingerprint feature extraction process adjusted in accordance with a fingerprint width degree.

6. The apparatus of claim 3, wherein the biometric data is a fingerprint data, the categories are categories defined by fingerprint width degrees, and the storage area of the authentication database is divided into a plurality of sub-areas for the respective fingerprint width degrees.

7. An authentication apparatus comprising:
an authentication data input unit which receives an input of biometric data of an object to be authenticated;
an assignment unit which assigns a category for the input biometric data from among a plurality of categories broadly defined by individual feature differences; and
a display unit which shows the category which has been assigned.

8. The apparatus of claim 7, further comprising:
an authentication database in which a storage area is divided into a plurality of sub-areas for the respective categories to register the biometric data of users; and
a registration unit which, based on the category assigned by the assignment unit, registers the input biometric data in the corresponding storage sub-area in the authentication database.

9. The apparatus of claim 7, wherein the biometric data is a fingerprint data and the categories are categories defined by fingerprint width degrees.

10. The apparatus of claim 8, wherein the biometric data is a fingerprint data, the categories are categories defined by fingerprint width degrees, and the storage area of the authentication database is divided into a plurality of sub-areas for the respective fingerprint width degrees.

11. An authentication method comprising:
receiving both an input of biometric data of an object to be authenticated and an input of data used to determine a category for the biometric data from among a plurality of categories broadly defined by individual feature differences;
implementing a feature extraction process appropriate for the category; and
performing a search in the authentication database in which the biometric data of users are registered for the respective categories and thereby collating the input biometric data of the object to be authenticated.

12. The method of claim 11, wherein the biometric data is a fingerprint data, the categories are categories defined by fingerprint width degrees, and the feature extraction process appropriate for the category is a fingerprint feature extraction process adjusted in accordance with a fingerprint width degree.

13. An authentication method comprising:
receiving an input of biometric data of an object to be authenticated;
assigning a category for the input biometric data from among a plurality of categories broadly defined by individual feature differences;
registering the input biometric data by correlating the assigned category with the input biometric data; and
displaying the assigned category.

14. The method of claim 13, wherein the biometric data is a fingerprint data, the categories are categories defined by fingerprint width degrees, and a storage area of the authentication database is divided into a plurality of sub-areas for the respective fingerprint width degrees.
